(19) United States
(12) Patent Application Publication
(10) Pub. No.: US 2021/0006742 A1
(43) Pub. Date: Jan. 7, 2021

(54) IMAGE SENSOR AND TIMING CONTROLLER THEREOF

(71) Applicant: Himax Imaging Limited, Tainan City (TW)

(72) Inventors: Hack soo Oh, Tainan City (TW); Amit Mittra, Tainan City (TW)

(21) Appl. No.: 16/504,321

(22) Filed: Jul. 7, 2019

(51) Int. Cl. H04N 5/376; H04N 5/3745; H04N 5/378; H04N 5/353

(52) U.S. Cl. CPC H04N 5/3765; H04N 5/353; H04N 5/378; H04N 5/37452

(57) ABSTRACT

An image sensor is provided, wherein the image sensor includes a pixel array and a timing controller coupled to the pixel array. The pixel array includes a plurality of pixel circuits, and each pixel circuit of pixel circuits includes a photodiode and a storage node. The timing controller includes a logic circuit for generating a plurality of control signals to respectively control operations of the pixel circuits within the pixel array. Respective photodiodes of the pixel circuits are concurrently reset to a first reference level before generating respective photodiode signals of the pixel circuits. Respective storage nodes of the pixel circuits are sequentially reset to a second reference level. The respective photodiode signals of the pixel circuits are concurrently transmitted to the respective storage nodes of the pixel circuits. The respective photodiode signals of the pixel circuits are sequentially read out from the respective storage nodes of the pixel circuits.

### BACKGROUND OF THE INVENTION

### 1. Field of the Invention

The present invention is related to operations of image sensors, and more particularly, to an image sensor (e.g. a global shutter Complementary Metal-Oxide-Semiconductor (CMOS) image sensor) and a timing controller thereof.

### 2. Description of the Prior Art

A global shutter image sensor has many advantages in comparison with a rolling shutter. In theory, the global shutter image sensor can obtain an image of a fast moving object with better quality than the rolling shutter image sensor can. Regarding the global shutter image sensor, operations of exposure and charge transfer are performed in a global manner (e.g. all pixel units are performed concurrently), but operations of read-out are performed in a rolling manner (e.g. row by row) due to limited hardware resources (limited number of read-out circuits such as analog-to-digital converters). Based on the above operations, it is typically required to hold respective signals of respective storage nodes of all pixel units (e.g. the respective signals stored on the respective storage nodes of all pixel units to be read) for different lengths of time (i.e. different holding times). In practice, these storage nodes may have some leakage paths, which may introduce error, and a compensation mechanism is usually needed. Since the holding times are different, errors are therefore different, and the compensation mechanism may become complicated. Thus, there is a need for a novel control mechanism and related architecture to solve the above problems.

### SUMMARY OF THE INVENTION

An objective of the present invention is to provide an image sensor (e.g. a global shutter Complementary Metal-Oxide-Semiconductor (CMOS) image sensor) and a timing controller thereof to solve the problems of the related art.

Another objective of the present invention is to provide an image sensor and a timing controller thereof to improve overall performance of the image sensor without introducing any side effect or in a way that is less likely to introduce side effects.

At least one embodiment of the present invention provides an image sensor. The image sensor comprises a pixel array and a timing controller coupled to the pixel array. The pixel array comprises a plurality of pixel circuits, wherein each pixel circuit of the pixel circuits comprises a photodiode configured to accumulate charges in response to incident radiation to generate a photodiode signal, and further comprises a storage node configured to store the photodiode signal after the photodiode signal is transmitted to the storage node. The timing controller comprises a logic circuit for generating a plurality of control signals to respectively control operations of the pixel circuits within the pixel array. In the operations of the pixel circuits, respective photodiodes of the pixel circuits are concurrently reset to a first reference level before generating respective photodiode signals of the pixel circuits; respective storage nodes of the pixel circuits are sequentially reset to a second reference level; the respective photodiode signals of the pixel circuits are concurrently transmitted to the respective storage nodes of the pixel circuits; and the respective photodiode signals of the pixel circuits are sequentially read out from the respective storage nodes of the pixel circuits.

At least one embodiment of the present invention provides a timing controller, wherein the image sensor comprising the timing controller and a pixel array coupled to the timing controller. The pixel array comprises a plurality of pixel circuits, and each pixel circuit of the pixel circuits comprises a photodiode configured to accumulate charges in response to incident radiation to generate a photodiode signal and a storage node configured to store the photodiode signal after the photodiode signal is transmitted to the storage node. The timing controller comprises a logic circuit configured to generate a plurality of control signals to respectively control operations of the pixel circuits within the pixel array. In the operations of the pixel circuits, respective photodiodes of the pixel circuits are concurrently reset to a first reference level before generating respective photodiode signals of the pixel circuits; respective storage nodes of the pixel circuits are sequentially reset to a second reference level; the respective photodiode signals of the pixel circuits are concurrently transmitted to the respective storage nodes of the pixel circuits; and the respective photodiode signals of the pixel circuits are sequentially read out from the respective storage nodes of the pixel circuits.

The present invention provides an image sensor and a timing controller thereof to guarantee respective errors of all pixels within the image sensor introduced by leakage currents to be identical, and thereby simplify subsequent compensation operations of read-out signals and improve overall performance of the image sensor. In addition, implementing the embodiments of the present invention will not greatly increase costs. Thus, the present invention can solve the problems of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an image sensor according to an embodiment of the present invention.

FIG. 2 is a circuit diagram illustrating a pixel circuit according to an embodiment of the present invention.

FIG. 3 is a timing diagram illustrating associated signals of pixel circuits within different pixel groups shown in FIG. 1 according to an embodiment of the present invention.

### DETAILED DESCRIPTION

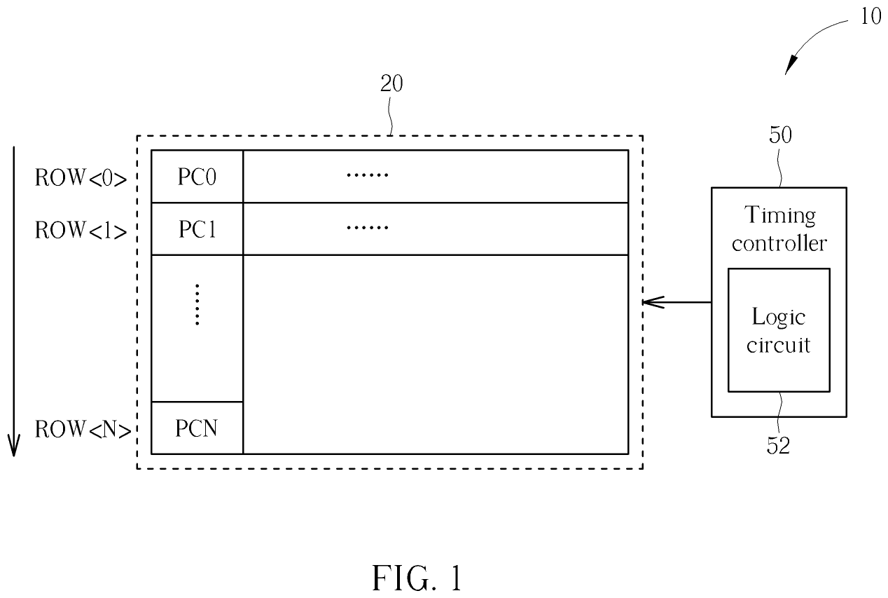

FIG. 1 is a diagram illustrating an image sensor 10 according to an embodiment of the present invention. More particularly, the image sensor 10 may be a global shutter Complementary Metal-Oxide-Semiconductor (CMOS) image sensor. As shown in FIG. 1, the image sensor 10 may comprise a pixel array 20 and a timing controller 50, where the timing controller is coupled to the pixel array. The pixel array 10 may comprise a plurality of pixel circuits, and the pixel circuits may be divided into a plurality of groups. For example, the pixel array 20 may comprise a plurality of pixel groups ROW<1>, ROW<2>, . . . and ROW<N>, where each of the pixel groups ROW<1>, ROW<2>, . . . and ROW<N> may comprise one or more pixel circuits. In this embodiment, “N” is a positive integer greater than one. Note that timing control operations of all pixel circuits within one pixel group may be identical, where any pixel circuit (e.g. each pixel circuit) of all pixel circuits within the pixel group ROW<0> may be referred to as the pixel circuit PC0, any pixel circuit (e.g. each pixel circuit) of all pixel circuits within the pixel group ROW<l> may be referred to as the pixel circuit PC1, . . . , and any pixel circuit (e.g. each pixel circuit) of all pixel circuits within the pixel group ROW<N> may be referred to as the pixel circuit PCN. In addition, the timing controller 50 may comprise a logic circuit 52 for generating a plurality of control signals to respectively control operations of the pixel circuits PC0, PC1, . . . and PCN within the pixel array 20.

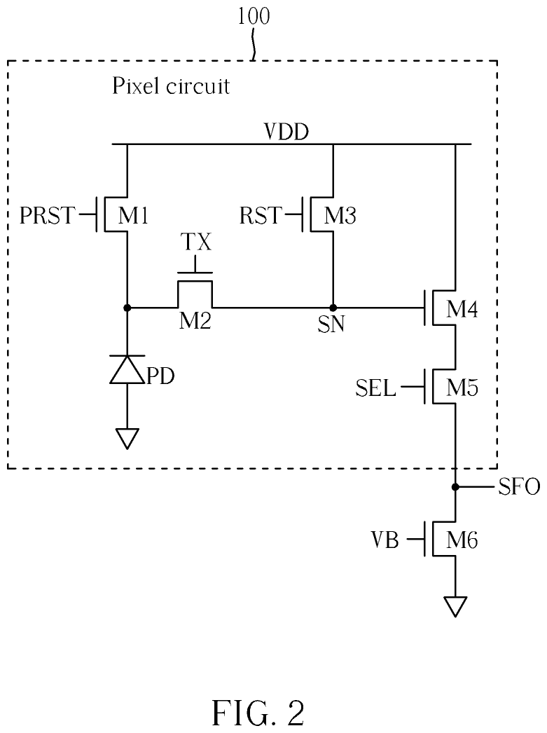

In this embodiment, each pixel circuit of the pixel circuits PC0, PC1, . . . and PCN may comprise a photodiode and a storage node, where the photodiode is configured to accumulate charges in response to incident radiation to generate a photodiode signal, and the storage node is configured to store the photodiode signal after the photodiode signal is transmitted to the storage node from the photodiode. FIG. 2 is a circuit diagram illustrating a pixel circuit 100 according to an embodiment of the present invention, where the pixel circuit 100 may be an example of the aforementioned each pixel circuit of the pixel circuits PC0, PC1, . . . and PCN. As shown in FIG. 2, the pixel circuit 100 may comprise a photodiode PD, a storage node SN, and a plurality of switches, where the plurality of switches are respectively implemented by transistors M1, M2, M3 and M5. The transistor M1 is coupled between a first reference voltage terminal and the photodiode PD, where the transistor M1 is controlled by a signal PRST to control timing of resetting the photodiode PD to a first reference level of the first reference voltage terminal. The transistor M3 is coupled between a second reference voltage terminal and the storage node SN, where the transistor M3 is controlled by a signal RST to control timing of resetting the storage node SN to a second reference level of the second reference voltage terminal. The transistor M2 is coupled between the photodiode PD and the storage node SN, where the transistor M2 is controlled by a signal TX to control timing of transmitting the photodiode signal to the storage node SN from the photodiode PD. The pixel circuit 100 may further comprise a transistor M4, where a gate terminal and a drain terminal of the transistor M4 are respectively coupled to the storage node SN and a third reference voltage terminal, and the transistor M5 is coupled between a source terminal of the transistor M4 and an output terminal SFO of the pixel circuit 100. The transistor M5 is controlled by a signal SEL to control timing of reading out signals (e.g. a reset signal corresponding to the second reference level and the photodiode signal) of the pixel circuit 100 from the storage node SN.

In this embodiment, the first reference voltage terminal, the second reference voltage terminal and the third reference voltage terminal are all coupled to a reference voltage terminal VDD, so the first reference level is equal to the second reference level, but the present invention is not limited thereto. In addition, a current source implemented by a transistor M6 (controlled by a bias voltage VB) is coupled to the output terminal SFO of the pixel circuit 100 in order to provide the transistor M4 with a bias voltage, but the present invention is not limited thereto.

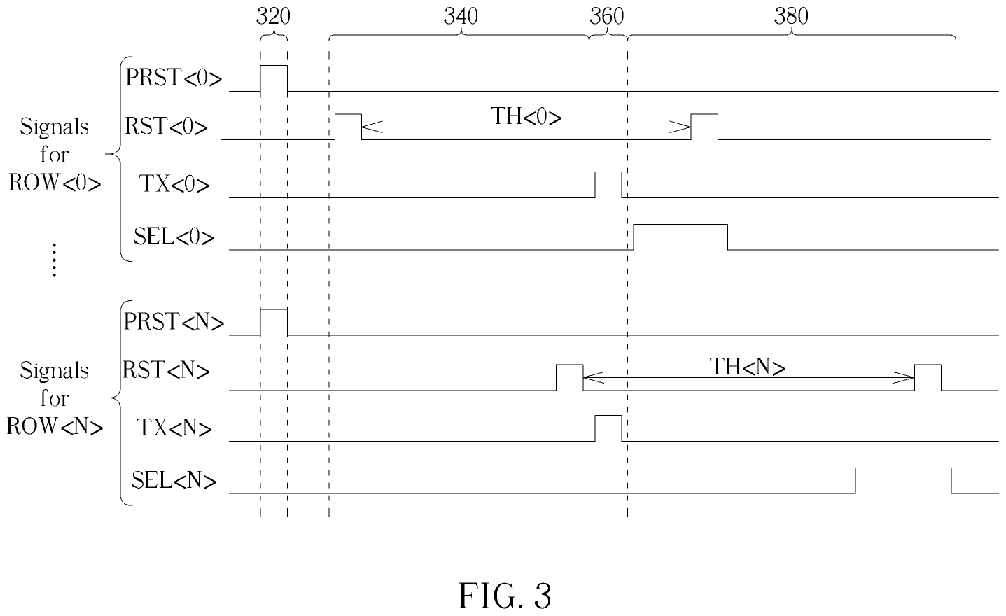

Please refer to FIG. 3 in conjunction with FIG. 1, where FIG. 3 is a timing diagram illustrating associated signals of the pixel circuits within the pixel groups ROW<0> and ROW<N> (e.g. the pixel circuits PC0 and PCN) shown in FIG. 1 according to an embodiment of the present invention. In this embodiment, the timing controller 50 may generate signals PRST<0>, RST<0>, TX<0> and SEL<0> to control operations of the pixel circuit PC0, and generate signals PRST<N>, RST<N>, TX<N> and SEL<N> to control operations of the pixel circuit PCN. The signals PRST<0>, RST<0>, TX<0> and SEL<0> may represent the signals PRST, RST, TX and SEL for the pixel circuit PC0, and the signals PRST<N>, RST<N>, TX<N> and SEL<N> may represent the signals PRST, RST, TX and SEL for the pixel circuit PCN. Note that FIG. 3 merely illustrates control signals of the first row of pixel circuits (e.g. the pixel circuit PC0) within the pixel array 20 and the last row of pixel circuits (e.g. the pixel circuit PCN) within the pixel array 20 for brevity, and control signals of the rest of pixel circuits within the pixel array 20 may be deduced by analogy.

During a phase 320 (which may be referred to as a global photodiode reset phase), the signals PRST<0>, . . . and PRST<N> concurrently turn to high (e.g. a logic high state) and concurrently return to low (e.g. a logic low state), which means respective photodiodes of the pixel circuits PC0, PC1, . . . and PCN are concurrently reset to the first reference level before generating respective photodiode signals of the pixel circuits PC0, PC1, . . . and PCN.

During a phase 340 (which may referred to as a rolling storage node reset phase), the signals RST<0>, . . . and RST<N> sequentially turn to high and sequentially return to low, which means respective storage nodes of the pixel circuits PC0, PC1, . . . and PCN are sequentially reset to the second reference level. More specifically, the respective storage nodes of the pixel circuits PC0, PC1, . . . and PCN are reset to the second reference level group by group (e.g. row by row).

During a phase 360 (which may referred to as a global photodiode signal transfer phase), the signals TX<0>, . . . and TX<N> concurrently turn to high and concurrently return to low, which means the respective photodiode signals of the pixel circuits PC0, PC1, . . . and PCN are concurrently transmitted to the respective storage nodes of the pixel circuits PC0, PC1, . . . and PCN.

During a phase 380 (which may referred to as a rolling read phase), the signals SEL<0>, . . . and SEL<N> sequentially turn to high, and the respective photodiode signals of the pixel circuits PC0, PC1, . . . and PCN are sequentially read out from the respective storage nodes of the pixel circuits PC0, PC1, . . . and PCN. Then, the signals RST<0>, . . . and RST<N> sequentially turn to high, and respective reset signals of the pixel circuits PC0, PC1, . . . and PCN are sequentially read out from the respective storage nodes of the pixel circuits PC0, PC1, . . . and PCN. More specifically, the respective photodiode signals and the respective reset signals of the pixel circuits PC0, PC1, . . . and PCN are read out from the respective storage nodes of the pixel circuits PC0, PC1, . . . and PCN group by group (e.g. row by row). Afterwards, the signals RST<0>/SEL<0>, . . . and RST<N>/SEL<N> sequentially return to low, and the read-out operations of this cycle can be done.

Regarding a time difference between a storage node of any pixel circuit of the pixel circuits PC0, PC1, . . . and PCN being reset to the second reference level and a photodiode signal of said any pixel circuit of the pixel circuits PC0, PC1, . . . and PCN being read out and a time difference between a storage node of another pixel circuit of the pixel circuits PC0, PC1, . . . and PCN being reset to the second reference level and a photodiode signal of said another pixel circuit of the pixel circuits PC0, PC1, . . . and PCN being read out are identical to each other. Taking the pixel circuit PC0 and PCN as examples of the aforementioned any pixel circuit and another pixel circuit, respectively, a time difference between the storage node of the pixel circuit PC0 being reset to the second reference level and the photodiode signal of the pixel circuit PC0 being read out, e.g. TH<0>, and a time difference between the storage node of the pixel circuit PCN being reset to the second reference level and the photodiode signal of the pixel circuit PCN being read out, e.g. TH<N>, may be designed to be identical to each other.

In practice, the storage node of each pixel circuit of the pixel circuits PC0, PC1, . . . and PCN may have a leakage current path, and an error value may be accumulated on the storage node during the period between the storage node of the aforementioned each pixel circuit being reset to the second reference level and the photodiode signal of the aforementioned each pixel circuit being read out. According to the above design, respective time periods for accumulating error values of the pixel circuits PC0, PC1, . . . and PCN can be identical, and a read-out error caused by the leakage current of the storage node of the aforementioned each pixel circuit can be identical to that of others within the pixel circuits. As a result, respective read-out errors of all pixel units within the pixel array caused by leakage current issue can be identical, and required compensation performed in backend processing regarding the read-out errors can be simplified.

It should be noted that the architecture of a single pixel circuit such as the pixel circuit 100 shown in FIG. 2 is for illustrative purposes only, and is not meant to be limitations of the present invention. As long as operations of resetting respective storage nodes of pixel circuits within an image sensor are performed in a rolling manner (e.g. performed sequentially such as group by group (e.g. row by row)) to make respective time periods for the respective storage nodes being affected by leakage currents be identical, the image sensor using any other suitable architecture should also belong to the present invention.

Briefly summarized, the present invention provides an image sensor and a timing controller thereof to guarantee respective errors of all pixels within the image sensor introduced by leakage currents to be identical, and thereby simplify subsequent compensation operations of read-out signals and improve overall performance of the image sensor. In addition, implementing according to embodiments of the present invention will not greatly increase costs. Thus, the present invention can solve the problems of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensor, comprising:
a pixel array, comprising a plurality of pixel circuits, wherein each pixel circuit of the pixel circuits comprises:
a photodiode, configured to accumulate charges in response to incident radiation to generate a photodiode signal; and
a storage node, configured to store the photodiode signal after the photodiode signal is transmitted to the storage node; and
a timing controller, coupled to the pixel array, wherein the timing controller comprises a logic circuit for generating a plurality of control signals to respectively control operations of the pixel circuits within the pixel array, and the operations of the pixel circuits comprise:
respective photodiodes of the pixel circuits are concurrently reset to a first reference level before generating respective photodiode signals of the pixel circuits;
respective storage nodes of the pixel circuits are sequentially reset to a second reference level;
the respective photodiode signals of the pixel circuits are concurrently transmitted to the respective storage nodes of the pixel circuits; and
the respective photodiode signals of the pixel circuits are sequentially read out from the respective storage nodes of the pixel circuits.

2. The image sensor of claim 1, wherein the pixel circuits are divided into a plurality of groups, the respective storage nodes of the pixel circuits are reset to the second reference level group by group, and the respective photodiode signals of the pixel circuits are read out from the respective storage nodes of the pixel circuits group by group.

3. The image sensor of claim 1, wherein the first reference level is equal to the second reference level.

4. The image sensor of claim 1, wherein a time difference between a storage node of any pixel circuit of the pixel circuits being reset to the second reference level and a photodiode signal of said any pixel circuit of the pixel circuits being read out and a time difference between a storage node of another pixel circuit of the pixel circuits being reset to the second reference level and a photodiode signal of said another pixel circuit of the pixel circuits being read out are identical to each other.

5. The image sensor of claim 1, wherein a read-out error caused by a leakage current of the storage node of said each pixel circuit is identical to that of others within the pixel circuits.

6. A timing controller of an image sensor, the image sensor comprising the timing controller and a pixel array coupled to the timing controller, the pixel array comprising a plurality of pixel circuits, each pixel circuit of the pixel circuits comprising a photodiode configured to accumulate charges in response to incident radiation to generate a photodiode signal and a storage node configured to store the photodiode signal after the photodiode signal is transmitted to the storage node, wherein the timing controller comprises:
a logic circuit, configured to generate a plurality of control signals to respectively control operations of the pixel circuits within the pixel array, wherein the operations of the pixel circuits comprises:
respective photodiodes of the pixel circuits are concurrently reset to a first reference level before generating respective photodiode signals of the pixel circuits;
respective storage nodes of the pixel circuits are sequentially reset to a second reference level;
the respective photodiode signals of the pixel circuits are concurrently transmitted to the respective storage nodes of the pixel circuits; and
the respective photodiode signals of the pixel circuits are sequentially read out from the respective storage nodes of the pixel circuits.

7. The timing controller of claim 6, wherein the pixel circuits are divided into a plurality of groups, the respective storage nodes of the pixel circuits are reset to the second reference level group by group, and the respective photodiode signals of the pixel circuits are read out from the respective storage nodes of the pixel circuits group by group.

8. The timing controller of claim 6, wherein the first reference level is equal to the second reference level.

9. The timing controller of claim 6, wherein a time differences between a storage node of any pixel circuit of the pixel circuits being reset to the second reference level and a photodiode signal of said any pixel circuit of the pixel circuits being read out and a time difference between a storage node of another pixel circuit of the pixel circuits being reset to the second reference level and a photodiode signal of said another pixel circuit of the pixel circuits being read out are identical to each other.

10. The timing controller of claim 6, wherein a read-out error caused by a leakage current of the storage node of said each pixel circuit is identical to that of others within the pixel circuits.
